(19) United States
(12) Patent Application Publication
(10) Pub. No.: US 2025/0360857 A1
(43) Pub. Date: Nov. 27, 2025

(54) AUTOMATIC CUP HOLDER

(71) Applicant: The Art of Complaint LLC, Greenbelt, MD (US)

(72) Inventor: Alexander Zajac, Greenbelt, MD (US)

(21) Appl. No.: 19/218,944

(22) Filed: May 27, 2025

Related U.S. Application Data
(60) Provisional application No. 63/652,145, filed on May 27, 2024.

(51) Int. Cl. B60N 3/10; G05B 11/01

(52) U.S. Cl. CPC B60N 3/10; G05B 11/01

(57) ABSTRACT

In some implementations, an automatic cup holder may include an enclosure partially surrounding a volume and having a recessed end for receiving a beverage holder, a sensor configured to perform a measurement associated with an acceleration of the system, a motor configured to rotate at least a portion of the enclosure, and a controller. The controller may be configured to detect that the measurement satisfies an acceleration threshold and to command the motor to rotate based on the measurement satisfying the acceleration threshold.

### CROSS-REFERENCE TO RELATED APPLICATION

This application claims priority to U.S. Provisional Patent Application No. 63/652,145, filed May 27, 2024, entitled “AUTOMATIC CUP HOLDER,” and assigned to the assignee hereof. The contents of the prior application are incorporated herein by reference.

### BACKGROUND

Liquid stored in a beverage holder is susceptible to spillage. In particular, as a vehicle (e.g., a car, a boat, or a plane, among other examples) turns, the liquid may experience acceleration and thus spill over sidewalls of the beverage holder (e.g., a tumbler or a disposable cup, among other examples). Additionally, such spillage may be increasingly likely when the liquid is subject to vertical displacement (e.g., due to the vehicle going uphill or downhill) as well as lateral acceleration.

### SUMMARY

In some implementations, a system may include an enclosure partially surrounding a volume and having a recessed end for receiving a beverage holder, a sensor configured to perform a measurement associated with an acceleration of the system, a motor configured to rotate at least a portion of the enclosure, and a controller. The controller may be configured to detect that the measurement satisfies an acceleration threshold and to command the motor to rotate based on the measurement satisfying the acceleration threshold.

In some implementations, a system may include at least one accelerometer configured to measure an acceleration of the system and a controller. The controller may be configured to detect that the acceleration satisfies an acceleration threshold and to trigger a command, to a motor, to rotate at least a portion of an enclosure having a recessed end for receiving a beverage holder, based on the acceleration satisfying the acceleration threshold.

In some implementations, a device may include one or more processors. The one or more processors may be configured to receive, from a sensor, a measurement associated with an acceleration of the sensor; determine that the measurement satisfies an acceleration threshold; and transmit a signal, based on the measurement satisfying the acceleration threshold, to a motor to trigger the motor to rotate at least a portion of an enclosure having a recessed end for receiving a beverage holder.

### BRIEF DESCRIPTION OF THE DRAWINGS

FIGS. 1A, 1B, 1C, 1D, and 1E are diagrams of example environments in which systems and/or methods described herein may be implemented, in accordance with some embodiments of the present disclosure.

FIGS. 2A, 2B, 2C, and 2D are diagrams of example implementations relating to an automatic cup holder, in accordance with some embodiments of the present disclosure.

FIG. 3 is a diagram of example components of one or more devices of FIGS. 1A-1E, in accordance with some embodiments of the present disclosure.

FIG. 4 is a flowchart of an example process relating to operation of an automatic cup holder, in accordance with some embodiments of the present disclosure.

### DETAILED DESCRIPTION

The following detailed description of example implementations refers to the accompanying drawings. The same reference numbers in different drawings may identify the same or similar elements.

Liquid stored in a beverage holder is susceptible to spillage. In particular, as a vehicle (e.g., a car, a boat, or a plane, among other examples) turns, the liquid may experience acceleration and thus spill over sidewalls of the beverage holder (e.g., a tumbler or a disposable cup, among other examples). Additionally, such spillage may be increasingly likely when the liquid is subject to vertical displacement (e.g., due to the vehicle going uphill or downhill) as well as lateral acceleration.

Some implementations described herein enable automatic rotation of a beverage holder in response to acceleration. As a result, spillage is reduced because an opening that would otherwise allow spillage over sidewalls of the beverage holder is automatically positioned based on directionality of the acceleration. For example, the opening may be positioned along a horizontal component of the acceleration. Additionally, or alternatively, the opening may be rotated along a direction determined based on an additional horizontal component and/or a vertical component of the acceleration.

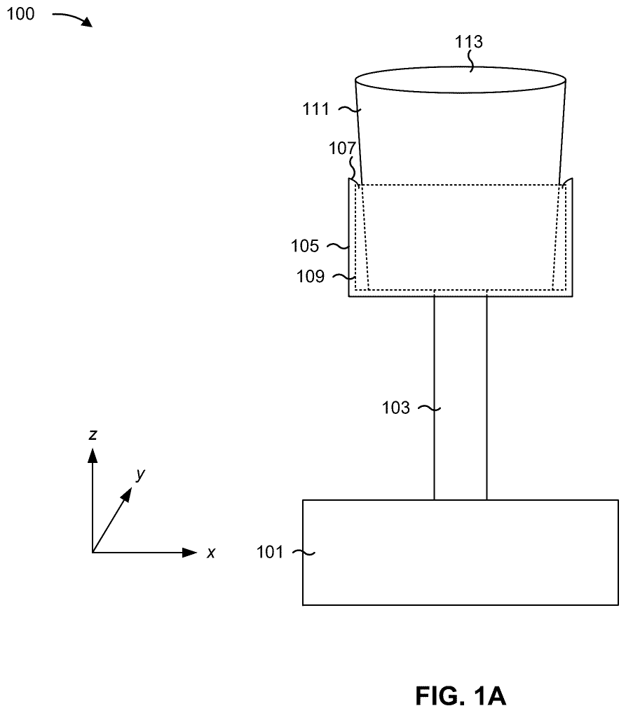

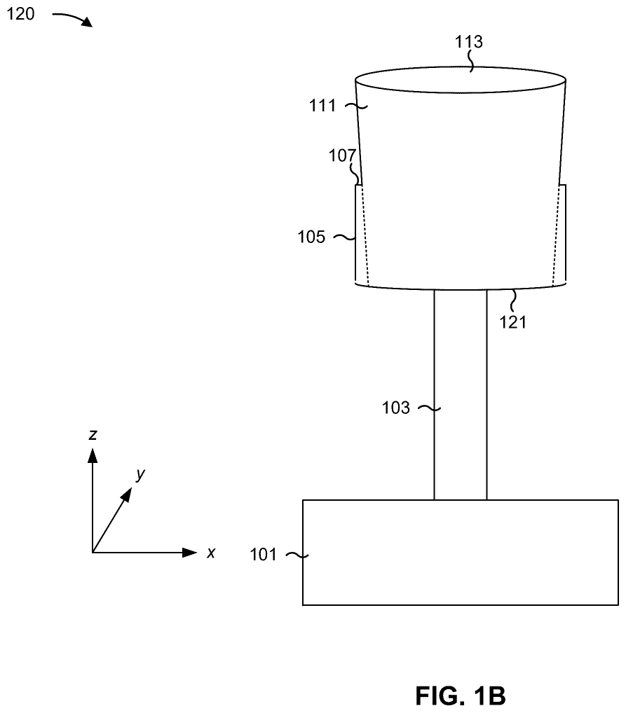

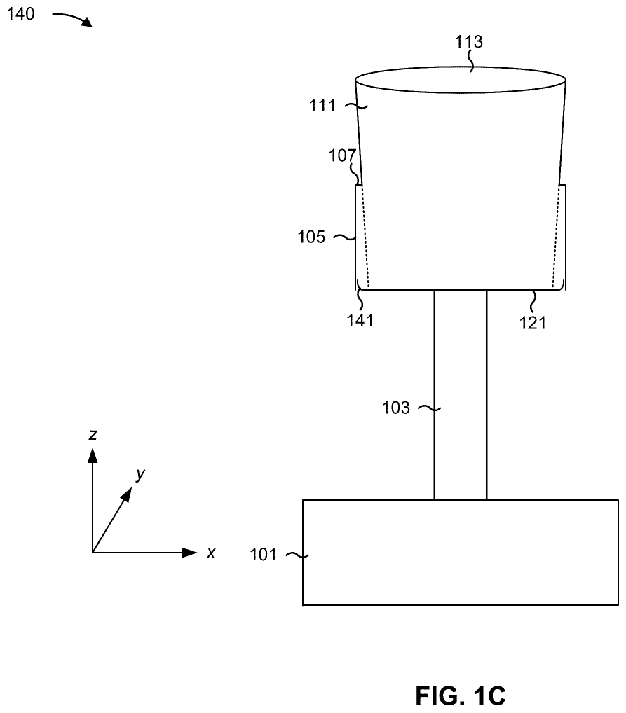

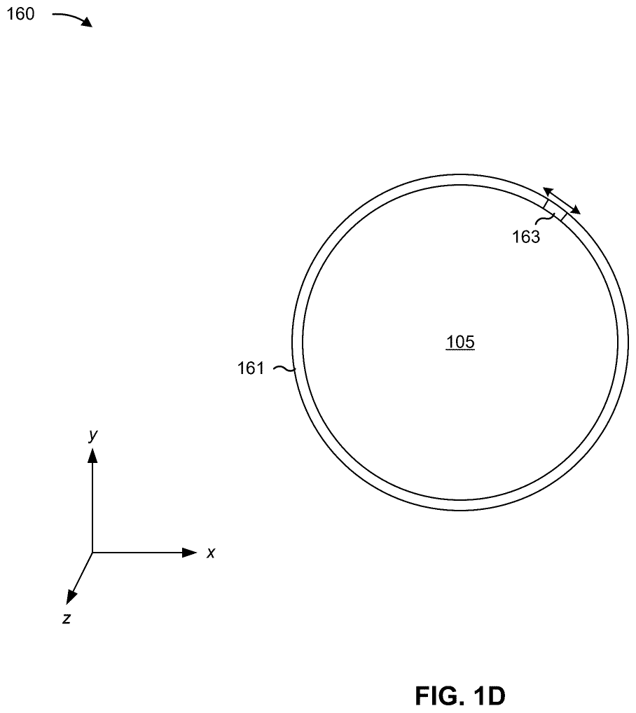

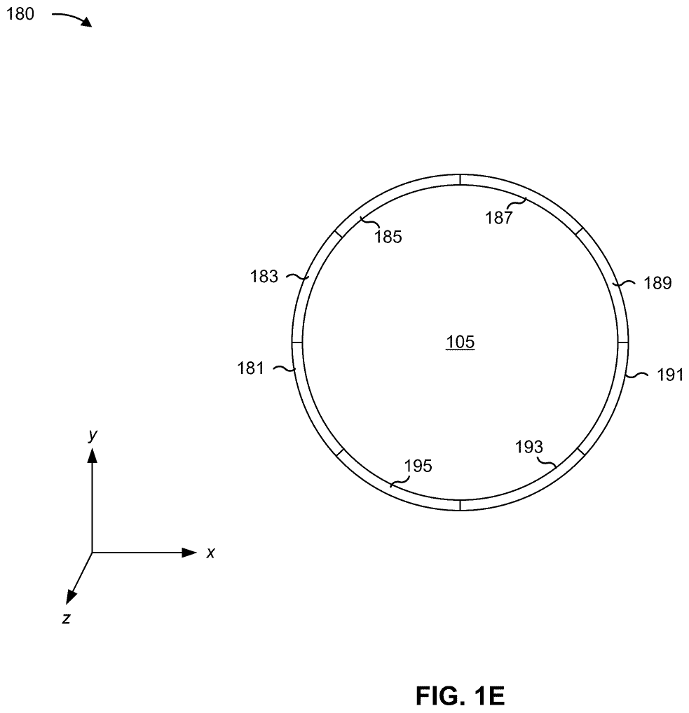

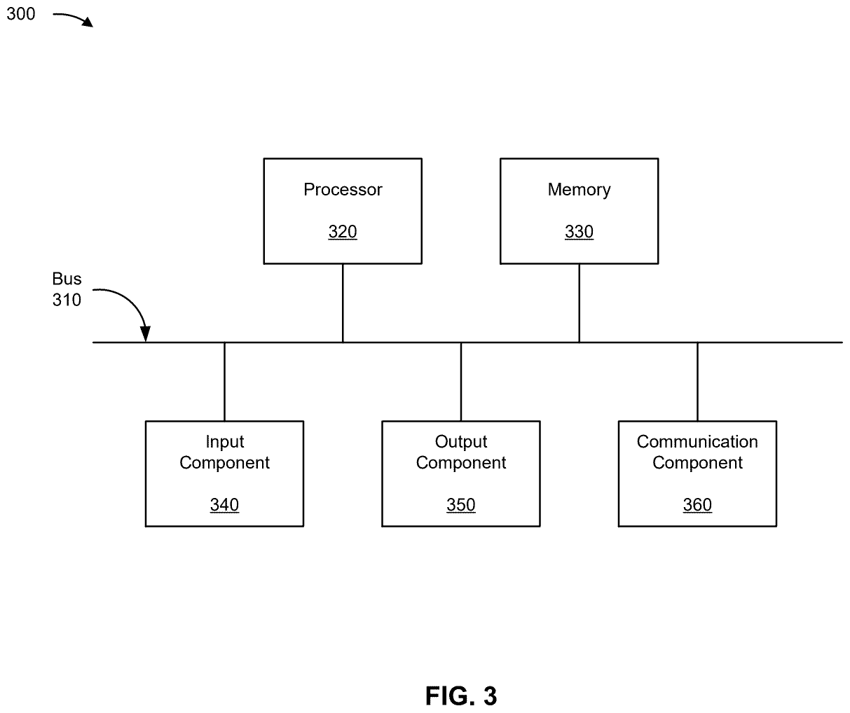

FIGS. 1A, 1B, 1C, 1D, and 1E depict example environments 100, 120, 140, 160, and 180, respectively, for implementing an automatic cup holder. Each environment may be controlled by a device as described in connection with FIG. 3.

As shown in FIG. 1A, the example environment 100 may include a motor 101. The motor 101 may be configured to rotate a shaft 103 or another type of solid material (e.g., a metal, a plastic or another type of solid polymer, and/or a metal alloy, among other examples). The motor 101 may include a synchronous motor, an induction motor, or another type of alternating current (AC) motor; a brushed motor, a brushless motor, or another type of direct current (DC) motor; and/or a rotary engine, among other examples. In FIG. 1A, the motor 101 is configured to rotate the shaft 103 such that the shaft 103 is characterized by an angular velocity that is along a vertical axis (that is, along an axis between the motor 101 and a stationary enclosure 105, represented by z in FIG. 1A).

The stationary enclosure 105 may be a cylinder or another type of solid material that surrounds a volume. As further shown in FIG. 1A, the stationary enclosure 105 may include a lip 107 that protrudes over the open end of the stationary enclosure 105. The lip 107 may be integral with the stationary enclosure 105 (e.g., formed in a same manufacturing process, such as a polymer extrusion process and/or a plastic molding process) or may be attached to the stationary enclosure 105 (e.g., via an adhesive or another type of bonding material).

In combination with a rotatable enclosure 109, the stationary enclosure 105 may form a combined enclosure for a beverage holder. For example, the rotatable enclosure 109 may be contained within the stationary enclosure 105. The combined enclosure may have one recessed end for receiving a beverage holder (e.g., cup 111, as described below). The lip 107 may be horizontal (e.g., along an axis that is perpendicular to the axis between the motor 101 and the stationary enclosure 105, represented by x in FIG. 1A) or may curve downward (e.g., away from the recessed end for receiving the beverage holder). Therefore, the lip 107 may direct liquid (e.g., spilled from the cup 111) into the rotatable enclosure 109 (and away from a space between sidewalls of the rotatable enclosure 109 and sidewalls of the stationary enclosure 105).

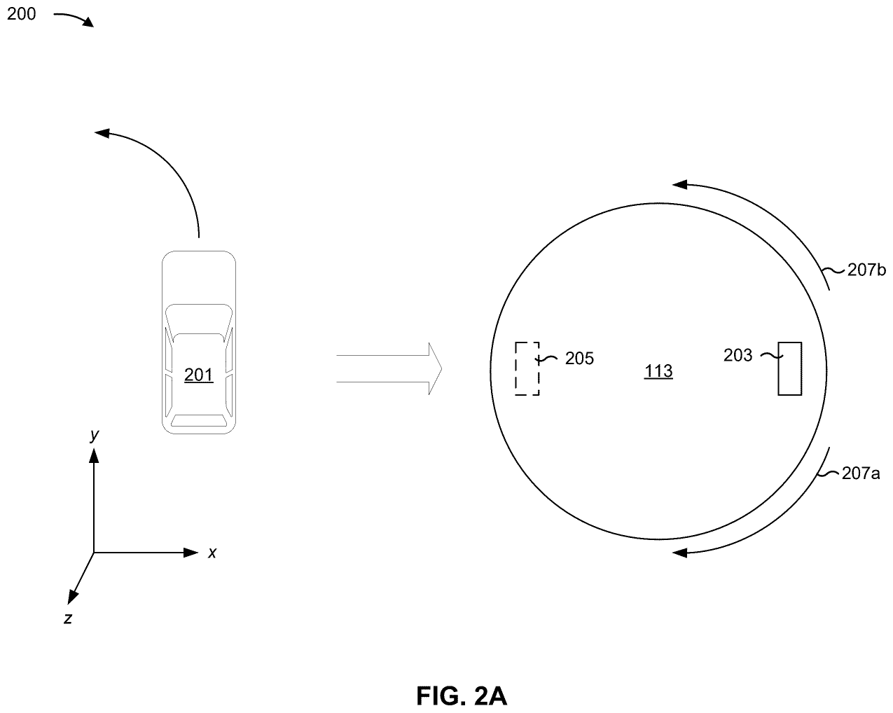

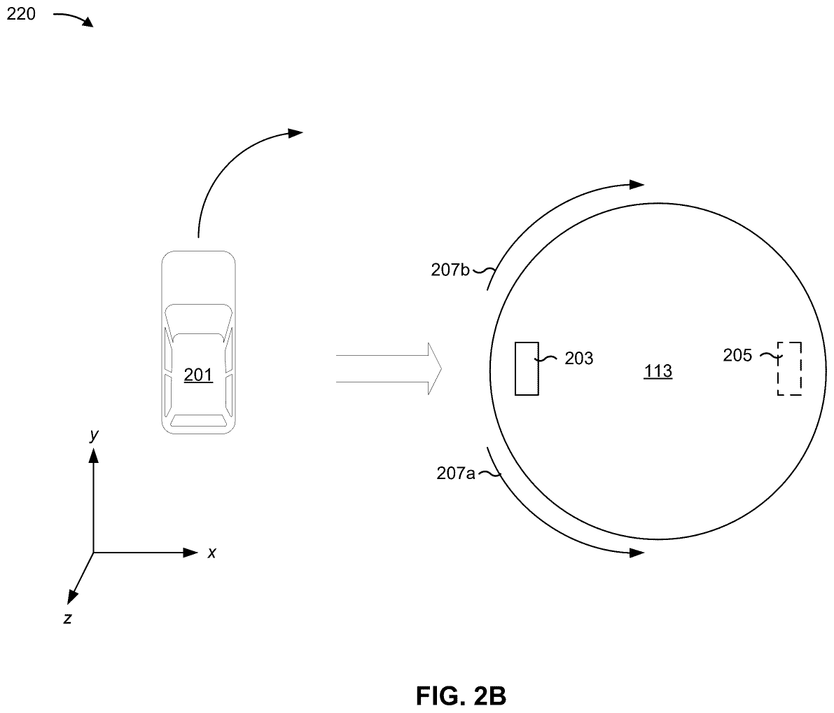

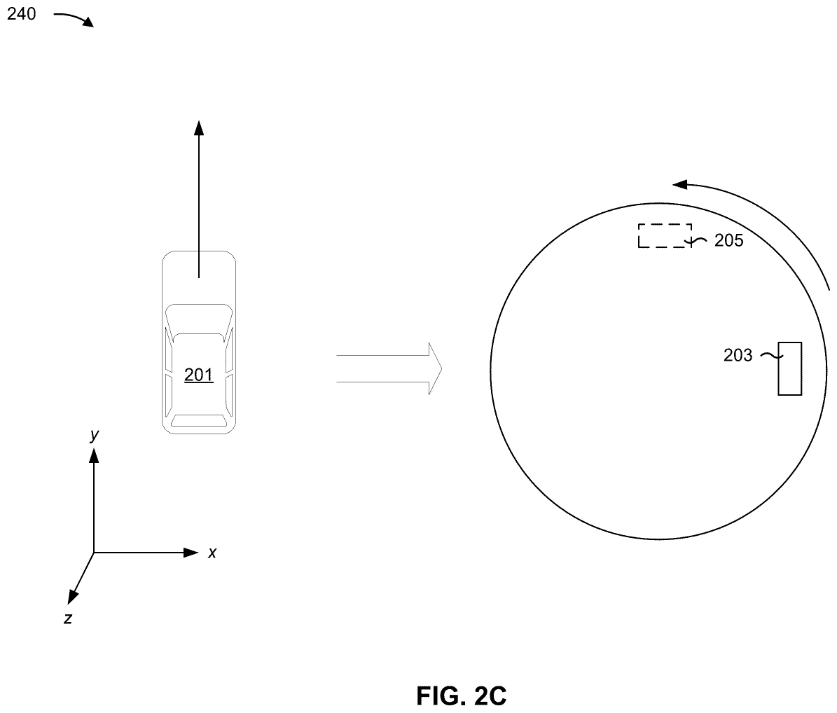

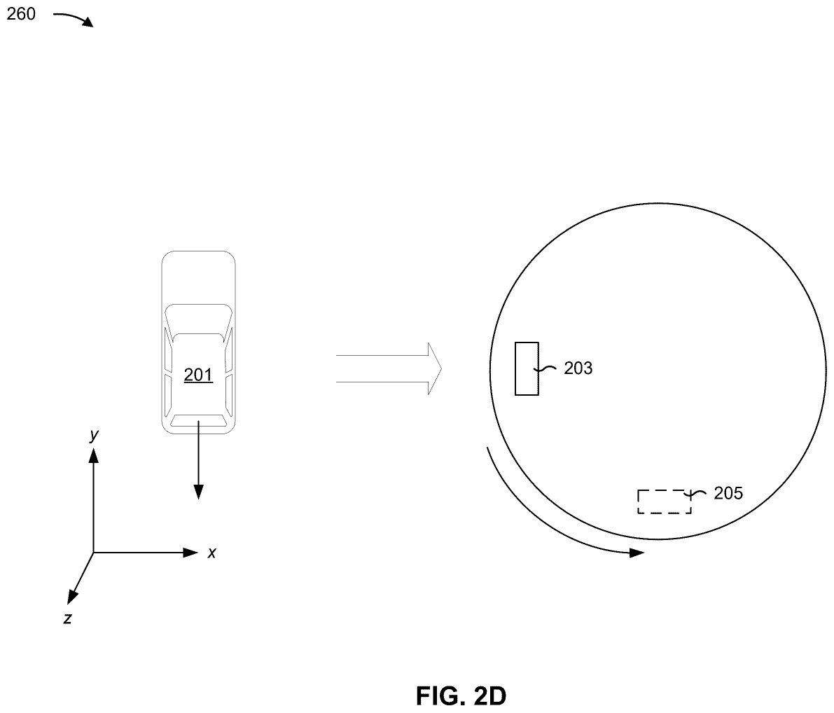

A bottom surface of the rotatable enclosure 109 may connect to the shaft 103. The rotatable enclosure 109 may be integral with the shaft 103 (e.g., formed in a same manufacturing process, such as a polymer extrusion process and/or a plastic molding process) or may be attached to the shaft 103 (e.g., via an adhesive or another type of bonding material). The shaft 103 may pass through a hole in the stationary enclosure 105 in order to connect to the bottom surface of the rotatable enclosure 109. Therefore, the motor 101 may rotate the rotatable enclosure 109 by rotating the shaft 103. The stationary enclosure 105 may remain fixed in space while the rotatable enclosure 109 rotates within the stationary enclosure 105. For example, the stationary enclosure 105 may be affixed (e.g., via an adhesive or another type of bonding material) to a support structure (e.g., a center console or another portion of a vehicle, as described in connection with FIGS. 2A-2D). Alternatively, the stationary enclosure 105 may be integral with the support structure (e.g., formed in a same manufacturing process, such as a polymer extrusion process and/or a plastic molding process).

The cup 111 may include a paper cup, a polymer cup (e.g., a polystyrene cup), a tumbler, and/or another type of beverage holder. The cup 111 may include a top surface 113 that is at least partially open (e.g., to allow liquid in the cup 111 to flow to a mouth of a user of the cup 111). Because the top surface 113 is at least partially open, the liquid in the cup 111 may slosh when accelerated. Therefore, the liquid in the cup 111 may spill through an opening in the top surface 113 (and/or over an edge of the top surface). In order to reduce (or even eliminate spillage), a controller (e.g., the device described in connection with FIG. 3) may communicate with the motor 101 in order to command the motor 101 to rotate based on a measurement associated with acceleration of the example environment 100. For example, the controller may command the motor 101 to rotate the rotatable enclosure 109 (and thus rotate the cup 111) toward a direction of the acceleration and thus away from a centrifugal force opposite the acceleration (e.g., as described in connection with FIGS. 2A-2D).

As shown in FIG. 1B, the example environment 120 may include the motor 101 and the shaft 103. Additionally, the example environment 120 may include the stationary enclosure 105. As further shown in FIG. 1B, the stationary enclosure 105 may include the lip 107 that protrudes over the open end of the stationary enclosure 105.

In combination with a rotatable surface 121, the stationary enclosure 105 may form a combined enclosure for a beverage holder. For example, the rotatable surface 121 may function as a bottom surface for the stationary enclosure 105. The combined enclosure may have one recessed end for receiving a beverage holder (e.g., the cup 111). The lip 107 may be horizontal (e.g., along an axis that is perpendicular to the axis between the motor 101 and the stationary enclosure 105, represented by x in FIG. 1B) or may curve downward (e.g., away from the recessed end for receiving the beverage holder). Therefore, the lip 107 may direct liquid (e.g., spilled from the cup 111) toward the rotatable surface 121 (and away from a space between the rotatable surface 121 and sidewalls of the stationary enclosure 105). Additionally, the rotatable surface 121 may slope away from the sidewalls of the stationary enclosure 105 (e.g., toward a central point of the rotatable surface 121) in order to direct liquid away from the space between the rotatable surface 121 and sidewalls of the stationary enclosure 105.

The rotatable surface 121 may be positioned in an open end of the stationary enclosure 105, and the rotatable surface 121 may connect to the shaft 103. The rotatable surface 121 may be integral with the shaft 103 (e.g., formed in a same manufacturing process, such as a polymer extrusion process and/or a plastic molding process) or may be attached to the shaft 103 (e.g., via an adhesive or another type of bonding material). Therefore, the motor 101 may rotate the rotatable surface 121 by rotating the shaft 103. The stationary enclosure 105 may remain fixed in space while the rotatable surface 121 rotates within (or at least around a perimeter of) the stationary enclosure 105. For example, the stationary enclosure 105 may be affixed (e.g., via an adhesive or another type of bonding material) to a support structure (e.g., a center console or another portion of a vehicle, as described in connection with FIGS. 2A-2D). Alternatively, the stationary enclosure 105 may be integral with the support structure (e.g., formed in a same manufacturing process, such as a polymer extrusion process and/or a plastic molding process).

As described in connection with FIG. 1A, in order to reduce (or even eliminate spillage), a controller (e.g., the device described in connection with FIG. 3) may communicate with the motor 101 in order to command the motor 101 to rotate based on a measurement associated with acceleration of the example environment 120. For example, the controller may command the motor 101 to rotate the rotatable surface 121 (and thus rotate the cup 111) toward a direction of the acceleration and thus away from a centrifugal force opposite the acceleration (e.g., as described in connection with FIGS. 2A-2D).

As shown in FIG. 1C, the example environment 140 may include the motor 101 and the shaft 103. Additionally, the example environment 140 may include the stationary enclosure 105. As further shown in FIG. 1C, the stationary enclosure 105 may include the lip 107 that protrudes over the open end of the stationary enclosure 105.

In combination with the rotatable surface 121, the stationary enclosure 105 may form a combined enclosure for a beverage holder. The lip 107 may be horizontal (e.g., along an axis that is perpendicular to the axis between the motor 101 and the stationary enclosure 105, represented by x in FIG. 1C) or may curve downward (e.g., away from the recessed end for receiving the beverage holder). Therefore, the lip 107 may direct liquid (e.g., spilled from the cup 111) toward the rotatable surface 121 (and away from a space between the rotatable surface 121 and sidewalls of the stationary enclosure 105).

As further shown in FIG. 1C, the rotatable surface 121 may include a lip 141 that extends upward from the rotatable surface 121. The lip 141 may be integral with the rotatable surface 121 (e.g., formed in a same manufacturing process, such as a polymer extrusion process and/or a plastic molding process) or may be attached to the rotatable surface 121 (e.g., via an adhesive or another type of bonding material). The lip 141 may curve upward (e.g., toward a recessed end of the stationary enclosure 105 for receiving the beverage holder). Therefore, the lip 141 may direct liquid (e.g., spilled from the cup 111) away from a space between the rotatable surface 121 and sidewalls of the stationary enclosure 105 (and toward a central point of the rotatable surface 121).

The rotatable surface 121 may be positioned in an open end of the stationary enclosure 105, and the rotatable surface 121 may connect to the shaft 103. The rotatable surface 121 may be integral with the shaft 103 (e.g., formed in a same manufacturing process, such as a polymer extrusion process and/or a plastic molding process) or may be attached to the shaft 103 (e.g., via an adhesive or another type of bonding material). Therefore, the motor 101 may rotate the rotatable surface 121 by rotating the shaft 103. The stationary enclosure 105 may remain fixed in space while the rotatable surface 121 rotates within (or at least around a perimeter of) the stationary enclosure 105. For example, the stationary enclosure 105 may be affixed (e.g., via an adhesive or another type of bonding material) to a support structure (e.g., a center console or another portion of a vehicle, as described in connection with FIGS. 2A-2D). Alternatively, the stationary enclosure 105 may be integral with the support structure (e.g., formed in a same manufacturing process, such as a polymer extrusion process and/or a plastic molding process).

As described in connection with FIG. 1A, in order to reduce (or even eliminate spillage), a controller (e.g., the device described in connection with FIG. 3) may communicate with the motor 101 in order to command the motor 101 to rotate based on a measurement associated with acceleration of the example environment 140. For example, the controller may command the motor 101 to rotate the rotatable surface 121 (and thus rotate the cup 111) toward a direction of the acceleration and thus away from a centrifugal force opposite the acceleration (e.g., as described in connection with FIGS. 2A-2D).

Features of the example environment 140 may be combined with features of the example environment 120 and/or the example environment 100. For example, the lip 141 described in connection with FIG. 1C may be included in the rotatable surface 121 of FIG. 1B. In another example, the lip 107 of FIG. 1C (which is horizontal) may be used in lieu of the lip 107 in FIG. 1A (which is curved). Additionally, or alternatively, features of the example environment 120 may be combined with features of the example environment 140 and/or the example environment 100. For example, the rotatable surface 121 of FIG. 1B (which is sloped) may be used in lieu of the rotatable surface 121 of FIG. 1C (which is flat). In another example, the sloping of the rotatable surface 121 in FIG. 1B may be used for a bottom surface of the rotatable enclosure 109 described in connection with FIG. 1A.

As shown in FIG. 1D, the example environment 160 may include the recessed end of the stationary enclosure 105. The recessed end may be surrounded by a control track 161. Therefore, a user in the example environment 160 may shift a control piece 163 around the control track 161. For example, the user may move the control piece 163 to indicate a location of an opening in the top surface 113 of the cup 111 (e.g., by moving the control piece 163 as close to the opening as possible along the control track 161). Therefore, a controller (e.g., the device described in connection with FIG. 3) may receive a signal (whether analog or digital) indicating an initial position associated with the combined enclosure, the rotatable enclosure 109, and/or the rotatable surface 121 (also referred to as an “origin point” for the opening) based on a location of the control piece 163 along the control track 161. For example, a voltage, a current, an amplitude, a frequency, and/or another property of the signal may vary depending on the location of the control piece 163 along the control track 161. Therefore, the controller may communicate with the motor 101 in order to command the motor 101 to rotate based on the initial position. For example, the controller may command the motor 101 to rotate (and thus rotate the cup 111) for an angular distance between the initial position and a terminal position or terminus (e.g., as described in connection with FIGS. 2A-2D).

As shown in FIG. 1E, the example environment 180 may include the recessed end of the stationary enclosure 105. The recessed end may be surrounded by a plurality of buttons (e.g., button 181, button 183, button 185, button 187, button 189, button 191, button 193, and button 195). Although the example environment 180 is shown with eight buttons, other examples may include fewer buttons (e.g., seven buttons, six buttons, and so on) or more buttons (e.g., nine buttons, ten buttons, and so on).

A user in the example environment 180 may push one of the plurality of buttons to indicate a location of an opening in the top surface 113 of the cup 111 (e.g., by pushing the button as close to the opening as possible). In some implementations, the buttons may be sticky. Therefore, pushing one button may cause another button that was previously pressed to pop up. Alternatively, the buttons may generate a signal without sticking such that pushing one button causes a previous signal from another button (that was previously pressed) to be discarded (in favor of the new signal).

A controller (e.g., the device described in connection with FIG. 3) may receive a signal (whether analog or digital) indicating an initial position associated with the combined enclosure, the rotatable enclosure 109, and/or the rotatable surface 121 (also referred to as an “origin point” for the opening) based on which button was most recently pushed. For example, a signal indicating the initial position may be generated in response to the button being pressed, and a version of the signal may be stored by the controller. Therefore, the controller may communicate with the motor 101 in order to command the motor 101 to rotate based on the initial position. For example, the controller may command the motor 101 to rotate (and thus rotate the cup 111) for an angular distance between the initial position and a terminal position or terminus (e.g., as described in connection with FIGS. 2A-2D).

Although FIGS. 1D-1E are described in connection with receiving a signal indicating the initial position (or the origin point), other examples may additionally or alternatively include receiving a signal indicating an acceleration threshold. For example, the user may input (e.g., via an input component, such as a touchscreen of an infotainment system or another type of input component) a signal indicating the acceleration threshold. In some implementations, the user may select from a plurality of possible acceleration thresholds. The plurality of possible acceleration thresholds may be indicated, to the user, using qualitative terms (e.g., “low sensitivity” to represent a smaller threshold or “high sensitivity” to represent a larger threshold, among other examples). The acceleration threshold may be used to determine when to transmit a command to the motor 101.

As indicated above, FIGS. 1A-1E are provided as examples. Other examples may differ from what is described with regard to FIGS. 1A-1E.

FIGS. 2A, 2B, 2C, and 2D depict example implementations 200, 220 240, and 260, respectively, of an automatic cup holder. Each implementation may be controlled by a device as described in connection with FIG. 3.

The device may be a controller (e.g., and may include one or more processors, as described in connection with FIG. 3). The device may further communicate with at least one sensor. The at least one sensor may be configured for perform a measurement associated with an acceleration of a system including the at least one sensor. In some implementations, the at least one sensor may measure an acceleration of the system (e.g., directly, using integrated circuits (IC), such that the measurement is the acceleration). Alternatively, the at least one sensor may measure the acceleration indirectly (e.g., the measurement may be an electrical measurement associated with a spring or a temperature measurement associated with a fluid, among other examples, which may be processed separately from the at least one sensor to obtain the acceleration). The at least one sensor may include an accelerometer and/or an inertial measurement unit (IMU). For example, the at least one sensor may include an accelerometer in an IMU.

As shown in FIG. 2A, the example implementation 200 includes the at least one sensor performing a measurement (associated with a horizontal acceleration, along an axis represented by x in FIG. 2A) that satisfies an acceleration threshold. For example, a vehicle 201 may turn to the left, which generates the horizontal acceleration (e.g., along a-x direction in FIG. 2A). Accordingly, the controller may command a motor to rotate based on the measurement satisfying the acceleration threshold. For example, the controller may trigger a command, to a motor, to rotate at least a portion of an enclosure (having a recessed end for receiving a beverage holder) based on the acceleration satisfying the acceleration threshold. Therefore, as shown in FIG. 2A, the top surface 113 of the beverage holder may be rotated based on the acceleration satisfying the acceleration threshold.

In some implementations, the command is further based on an initial position (e.g., associated with an opening 203 in the top surface 113 of the beverage holder). The initial position may be a default position or may be indicated by a user of the vehicle 201 (e.g., as described in connection with FIGS. 1D-1E). The controller may communicate with one or more memories (e.g., as described in connection with FIG. 3) that store an indication of the initial position. The command may therefore trigger rotation from the initial position to a terminus 205. The terminus 205 may be at least one terminal position, and an indication of the at least one terminal position may be stored in the one or more memories (e.g., together with, or separately from, the initial position). In some implementations, the controller may select from a plurality of terminal positions stored in the one or more memories. For example, the controller may identify a selected terminal position, from the plurality of terminal positions, based on the measurement. Therefore, in the example implementation 200, the controller identifies a terminal position (for the opening 203) that is furthest along a direction of the acceleration (that is, the terminal position is on the left because the centrifugal force is rightward, as caused by turning the vehicle 201 to the left). In other words, the controller may determine the terminus 205 (for the motor) based on a horizontal component of the acceleration (e.g., a component associated with an axis along seats and/or doors of the vehicle 201, represented by x in FIG. 2A).

As further shown in FIG. 2A, the motor may rotate the opening 203 (of the beverage holder) toward the terminus 205 along a first direction 207a or a second direction 207b. In some implementations, the at least one sensor may perform a measurement associated with a multi-dimensional acceleration. Therefore, the controller may use a first horizontal component of the multi-dimensional acceleration to trigger the command (based on satisfying the acceleration threshold) and to determine the terminus 205 (e.g., to identify a selected terminal position, from the plurality of terminal positions, furthest along a direction of the horizontal component). Additionally, the controller may use a second horizontal component (e.g., along an axis represented by y in FIG. 2A) of the multi-dimensional acceleration to determine the direction of rotation. For example, the controller may identify a selected direction, from the first direction 207a or the second direction 207b, that is closer to a direction of the acceleration (e.g., selecting the first direction 207a based on the vehicle 201 slowing down or the second direction 207b based on the vehicle 201 speeding up). The second horizontal component of the acceleration may be associated with an axis along a hood and trunk of the vehicle 201 (e.g., represented by y in FIG. 2A).

As shown in FIG. 2B, the example implementation 220 is similar to the example implementation 200 but includes the vehicle 201 turning to the right. In FIG. 2B, the top surface 113 of the beverage holder may be rotated based on the acceleration satisfying the acceleration threshold.

Additionally, the command to rotate is further based on an initial position (e.g., associated with the opening 203 in the top surface 113 of the beverage holder). The command may therefore trigger rotation from the initial position to the terminus 205. The controller may determine the terminus 205 by identifying a selected terminal position, from the plurality of terminal positions, based on the measurement. Therefore, in the example implementation 220, the controller identifies a terminal position (for the opening 203) that is furthest along a direction of the acceleration (that is, the terminal position is on the right because the centrifugal force is leftward, as caused by turning the vehicle 201 to the right). In other words, the controller may determine the terminus 205 (for the motor) based on the horizontal component of the acceleration (e.g., along an axis represented by x in FIG. 2B).

As further shown in FIG. 2B, the motor may rotate the opening 203 (of the beverage holder) toward the terminus 205 along the first direction 207a or the second direction 207b. In some implementations, the controller may use a first horizontal component of a multi-dimensional acceleration to trigger the command (based on satisfying the acceleration threshold) and to determine the terminus 205 (e.g., to identify a selected terminal position, from the plurality of terminal positions, furthest along a direction of the horizontal component). Additionally, the controller may use a second horizontal component (e.g., along an axis represented by y in FIG. 2B) of the multi-dimensional acceleration to determine the direction of rotation. For example, the controller may identify a selected direction, from the first direction 207a or the second direction 207b, that is closer to a direction of the acceleration (e.g., selecting the first direction 207a based on the vehicle 201 slowing down or the second direction 207b based on the vehicle 201 speeding up).

Although the example implementations 200 and 220 are described in connection with using acceleration measurements, other examples implementations may additionally or alternatively use signals from an input device (e.g., a steering wheel) of the vehicle 201. For example, a user of the vehicle 201 may provide input that instructs the vehicle 201 to turn left, and the controller may receive a signal representing the input. In response to the signal, the controller may trigger the command to rotate, as described in connection with FIG. 2A, based on the input representing an instruction to turn left. In another example, a user of the vehicle 201 may provide input that instructs the vehicle 201 to turn right, and the controller may receive a signal representing the input. In response to the signal, the controller may trigger the command to rotate, as described in connection with FIG. 2B, based on the input representing an instruction to turn right.

As shown in FIG. 2C, the example implementation 240 includes the at least one sensor performing a measurement (associated with a horizontal acceleration) that satisfies an acceleration threshold. For example, a vehicle 201 may accelerate along a road, which generates the horizontal acceleration (e.g., along an axis represented by y in FIG. 2C). Accordingly, the controller may command a motor to rotate based on the measurement satisfying the acceleration threshold. For example, the controller may trigger a command, to a motor, to rotate at least a portion of an enclosure (having a recessed end for receiving a beverage holder) based on the acceleration satisfying the acceleration threshold. Therefore, as shown in FIG. 2C, the top surface 113 of the beverage holder may be rotated based on the acceleration satisfying the acceleration threshold.

In some implementations, the command is further based on an initial position (e.g., associated with an opening 203 in the top surface 113 of the beverage holder). The initial position may be a default position or may be indicated by a user of the vehicle 201 (e.g., as described in connection with FIGS. 1D-1E). the controller may communicate with one or more memories (e.g., as described in connection with FIG. 3) that store an indication of the initial position. The command may therefore trigger rotation from the initial position to a terminus 205. The terminus 205 may be at least one terminal position, and an indication of the at least one terminal position may be stored in the one or more memories (e.g., together with, or separately from, the initial position). In some implementations, the controller may select from a plurality of terminal positions stored in the one or more memories. For example, the controller may identify a selected terminal position, from the plurality of terminal positions, based on the measurement. Therefore, in the example implementation 200, the controller identifies a terminal position (for the opening 203) that is furthest along a direction of the acceleration (that is, the terminal position is at the top because the inertial force is toward a back of the vehicle 201 as caused by the vehicle 201 speeding up). In other words, the controller may determine the terminus 205 (for the motor) based on a vertical component of the acceleration (e.g., a component associated with an axis along a hood and trunk of the vehicle 201, represented by y in FIG. 2C).

In some implementations, and similarly as described in connection with FIGS. 1A-1B, the motor may rotate the opening 203 (of the beverage holder) toward the terminus 205 along one of a plurality of directions. In some implementations, the at least one sensor may perform a measurement associated with a multi-dimensional acceleration. Therefore, the controller may use a first horizontal component of the multi-dimensional acceleration to trigger the command (based on satisfying the acceleration threshold) and to determine the terminus 205 (e.g., to identify a selected terminal position, from the plurality of terminal positions, furthest along a direction of the horizontal component). Additionally, the controller may use a second horizontal component (e.g., along an axis represented by x in FIG. 2C) of the multi-dimensional acceleration to determine the direction of rotation. For example, the controller may identify a selected direction, from the plurality of directions, closer to a direction of acceleration (e.g., selecting a direction along a right side of the vehicle 201 based on the vehicle 201 turning right or a direction along a left side of the vehicle 201 based on the vehicle 201 turning left). The horizontal component of the acceleration may be associated with an axis along seats and/or doors of the vehicle 201 (e.g., represented by x in FIG. 2C).

As shown in FIG. 2D, the example implementation 260 is similar to the example implementation 240 but includes the vehicle 201 decelerating. In FIG. 2D, the top surface 113 of the beverage holder may be rotated based on the acceleration satisfying the acceleration threshold.

Additionally, the command to rotate is further based on an initial position (e.g., associated with the opening 203 in the top surface 113 of the beverage holder). The command may therefore trigger rotation from the initial position to the terminus 205. The controller may determine the terminus 205 by identifying a selected terminal position, from the plurality of terminal positions, based on the measurement. Therefore, in the example implementation 220, the controller identifies a terminal position (for the opening 203) that is furthest along a direction of acceleration (that is, the terminal position is at the bottom because an inertial force is toward a front of the vehicle 201 as caused by the vehicle 201 slowing down). In other words, the controller may determine the terminus 205 (for the motor) based on the horizontal component of the acceleration (e.g., along an axis represented by y in FIG. 2D).

In some implementations, and similarly as described in connection with FIGS. 1A-1B, the motor may rotate the opening 203 (of the beverage holder) toward the terminus 205 along one of a plurality of directions. In some implementations, the controller may use a first horizontal component of a multi-dimensional acceleration to trigger the command (based on satisfying the acceleration threshold) and to determine the terminus 205 (e.g., to identify a selected terminal position, from the plurality of terminal positions, furthest along a direction of the vertical component). Additionally, the controller may use a second horizontal component (e.g., along an axis represented by x in FIG. 2D) of the multi-dimensional acceleration to determine the direction of rotation. For example, the controller may identify a selected direction, from the plurality of directions, closer to a direction of acceleration (e.g., selecting a direction along a right side of the vehicle 201 based on the vehicle 201 turning right or a direction along a left side of the vehicle 201 based on the vehicle 201 turning left).

Although the example implementations 240 and 260 are described in connection with using acceleration measurements, other examples implementations may additionally or alternatively use signals from an input device (e.g., a gas pedal and/or a brake pedal) of the vehicle 201. For example, a user of the vehicle 201 may provide input that instructs the vehicle 201 to accelerate, and the controller may receive a signal representing the input. In response to the signal, the controller may trigger the command to rotate, as described in connection with FIG. 2C, based on the input representing an instruction to accelerate. In another example, a user of the vehicle 201 may provide input that instructs the vehicle 201 to decelerate, and the controller may receive a signal representing the input. In response to the signal, the controller may trigger the command to rotate, as described in connection with FIG. 2D, based on the input representing an instruction to decelerate.

Although the example implementations 200, 220, 240, and 260 are described in connection with at least one sensor performing a measurement associated with multi-dimensional acceleration, other examples may include one sensor configured to perform a measurement associated with a horizontal direction and an additional sensor configured to perform an additional measurement associated with a vertical direction (e.g., along an axis represented by z in FIGS. 2A-2D). Accordingly, the command may be based on the measurement associated with the horizontal direction satisfying a horizontal threshold and further based on the additional measurement associated with the vertical direction satisfying a vertical threshold. In another example, one sensor may be configured to perform a measurement associated with a first horizontal direction (e.g., along an axis represented by x in FIGS. 2A-2D) and an additional sensor may be configured to perform an additional measurement associated with a second horizonal direction (e.g., along an axis represented by y in FIGS. 2A-2D) that is perpendicular to the first horizontal direction. Accordingly, the command may be based on the measurement satisfying an acceleration threshold and further based on the additional measurement satisfying an additional acceleration threshold.

The additional sensor may also include an accelerometer, an IMU, and/or an accelerometer in an IMU. Alternatively, the additional sensor may include a position sensor (e.g., a magnetometer configured to perform magnetic measurements). Therefore, the measurement may be associated with a slope (e.g., of the vehicle 201). The slope may be along the vertical direction. Therefore, the command may be based on the acceleration satisfying an acceleration threshold and further based on the slope satisfying an incline threshold. Additionally, or alternatively, the controller may use a horizontal component of acceleration to trigger the command (based on satisfying the acceleration threshold) and to determine the terminus 205 (e.g., to identify a selected terminal position, from the plurality of terminal positions, furthest along a direction of the vertical component). Additionally, the controller may use the slope (and/or a vertical component of acceleration) to determine the direction of rotation. For example, the controller may identify a selected direction, from the plurality of directions, closer to a direction of acceleration (e.g., selecting a direction along a rear end of the vehicle 201, represented by −y in FIGS. 2A-2D, based on the vehicle 201 going downhill or a direction along a front end of the vehicle 201, represented by +y in FIGS. 2A-2D, based on the vehicle 201 going uphill).

As indicated above, FIGS. 2A-2D are provided as examples. Other examples may differ from what is described with regard to FIGS. 2A-2D.

FIG. 3 is a diagram of example components of a device 300, which may correspond to a control device in an automatic cup holder. In some implementations, the control device may include one or more devices 300 and/or one or more components of device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

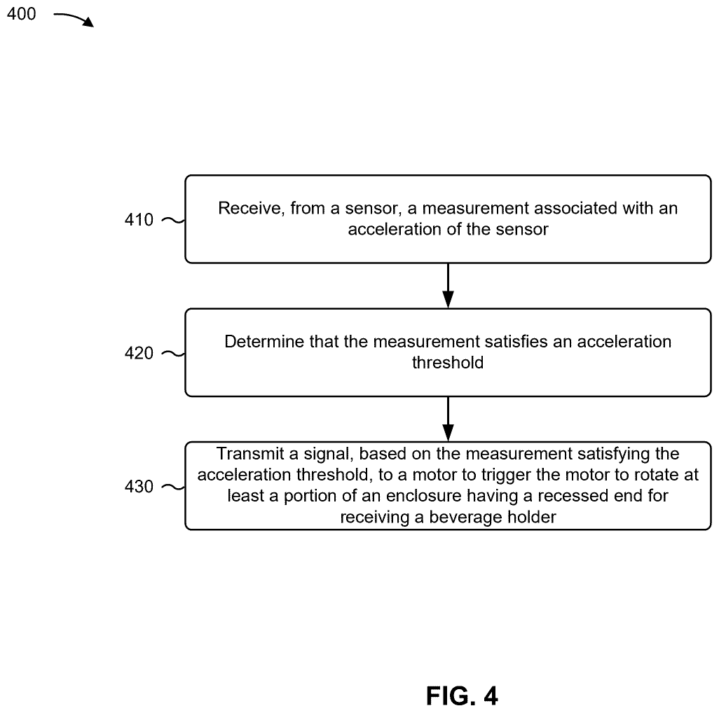

FIG. 4 is a flowchart of an example process 400 associated with using an automated cup holder. In some implementations, one or more process blocks of FIG. 4 may be performed by a control device. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving, from a sensor, a measurement associated with an acceleration of the sensor (block 410). For example, the control device (e.g., using processor 320, memory 330, input component 340, and/or communication component 360) may receive a measurement associated with an acceleration of a sensor.

As further shown in FIG. 4, process 400 may include determining that the measurement satisfies an acceleration threshold (block 420). For example, the control device (e.g., using processor 320 and/or memory 330) may determine that the measurement satisfies an acceleration threshold.

As shown in FIG. 4, process 400 may include transmitting a signal, based on the measurement satisfying the acceleration threshold, to a motor to trigger the motor to rotate at least a portion of an enclosure having a recessed end for receiving a beverage holder (block 430). For example, the control device (e.g., using processor 320, memory 330, output component 350, and/or communication component 360) may transmit a signal to a motor to trigger the motor to rotate at least a portion of an enclosure having a recessed end for receiving a beverage holder, based on the measurement satisfying the acceleration threshold.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
an enclosure partially surrounding a volume and having a recessed end for receiving a beverage holder;
a sensor configured to perform a measurement associated with an acceleration of the system;
a motor configured to rotate at least a portion of the enclosure; and
a controller configured to detect that the measurement satisfies an acceleration threshold and to command the motor to rotate based on the measurement satisfying the acceleration threshold.

2. The system of claim 1, wherein the sensor comprises an accelerometer.

3. The system of claim 1, wherein the measurement is associated with a horizontal direction, and the system further comprises:
an additional sensor configured to perform an additional measurement associated with a vertical direction,
wherein the controller is further configured to detect that the additional measurement satisfies a vertical threshold, and the command is further based on the additional measurement satisfying the vertical threshold.

4. The system of claim 3, wherein the additional sensor comprises an accelerometer or a position sensor.

5. The system of claim 1, wherein the command is further based on an origin point.

6. The system of claim 5, further comprising:
a memory storing an indication of the origin point.

7. The system of claim 5, further comprising:
at least one input component configured to receive a signal indicating the origin point.

8. The system of claim 1, wherein the measurement is associated with a first horizontal direction, and the system further comprises:
an additional sensor configured to perform an additional measurement associated with a second horizonal direction that is perpendicular to the first horizontal direction,
wherein the controller is further configured to detect that the additional measurement satisfies an additional acceleration threshold, and the command is further based on the additional measurement satisfying the additional acceleration threshold.

9. A system, comprising:
at least one accelerometer configured to measure an acceleration of the system; and
a controller configured to detect that the acceleration satisfies an acceleration threshold and to trigger a command to a motor, to rotate at least a portion of an enclosure having a recessed end for receiving a beverage holder, based on the acceleration satisfying the acceleration threshold.

10. The system of claim 9, wherein the accelerometer is included in an inertial measurement unit (IMU).

11. The system of claim 9, further comprising:
at least one input component configured to receive a signal indicating the acceleration threshold.

12. The system of claim 9, wherein the acceleration includes a vertical component and a horizontal component, the command indicates a direction and a terminus, and the controller is further configured to determine the direction based on the vertical component and to determine the terminus based on the horizontal component.

13. The system of claim 9, further comprising:
a position sensor configured to measure a slope associated with the system,
wherein the controller is further configured to detect that the slope satisfies an incline threshold, and the command is further based on the slope satisfying the incline threshold.

14. A device, comprising:
one or more processors configured to:
receive, from a sensor, a measurement associated with an acceleration of the sensor;
determine that the measurement satisfies an acceleration threshold; and
transmit a signal, based on the measurement satisfying the acceleration threshold, to a motor to trigger the motor to rotate at least a portion of an enclosure having a recessed end for receiving a beverage holder.

15. The device of claim 14, wherein the measurement is associated with a single axis.

16. The device of claim 14, wherein the measurement is associated with a plurality of axes.

17. The device of claim 14, wherein the one or more processors are further configured to:
receive a signal indicating an initial position associated with the enclosure,
wherein the signal to the motor is further based on the initial position.

18. The device of claim 14, further comprising:
one or more memories storing an indication of at least one terminal position,
wherein the signal to the motor is further based on the at least one terminal position.

19. The device of claim 14, further comprising:
one or more memories storing an indication of a first terminal position and an indication of a second terminal position,
wherein the one or more processors are further configured to identify a selected terminal position, from the first terminal position or the second terminal position, based on the measurement, and wherein the signal to the motor is further based on the selected terminal position.

20. The device of claim 14, wherein the one or more processors are further configured to:
receive a signal indicating the acceleration threshold.
